(19) United States
(12) Patent Application Publication
(10) Pub. No.: US 2007/0276945 A1
(43) Pub. Date: Nov. 29, 2007

(54) Fault-Tolerant Resource Committal

(75) Inventors: Sankaran Narayanan, Bellevue, WA (US); Dhigha D. Sekaran, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/419,924

(22) Filed: May 23, 2006

(51) Int. Cl. G06F 15/173

(52) U.S. Cl. 709/226; 709/223

(57) ABSTRACT

This document describes tools that enable fault-tolerant resource committal for a system having computing devices needing to have operations of a particular type performed by one of multiple external resources. The tools may do so without relying on leadership from a pre-selected or altered computing device. Assume, for example, that the system is a conferencing system, the computing devices are front-end servers, the operations of a particular type are those that require handling of audio from users in the conference, and the external resources are homogeneous audio multi-point control units (MCUs) each of which is capable of handling audio from all of the users. The tools may enable, in one embodiment, any of the front-end servers to allocate a single audio MCU and commit all of the other front-end servers to use that single MCU for their audio operations.

### BACKGROUND

Many systems have computing devices that need a single external resource to perform operations of a particular type but have multiple resources from which to choose. Assume, for example, that a bank's computing system has two devices that have each prepared half of a particular document for printing and many available printing resources (e.g., laser printers). To print the document on one printer, the bank's computing system needs to allocate one of many available printers and commit the system's two devices to that one printer. If both of the devices are committed to that one printer, that same printer can print both halves of the document. Or, also for example, assume that a conferencing system has many devices each of which handles audio from different conference users but needs one of multiple audio multi-point control units (MCUs) to handle all of the different users' audio. To enable this, the system may allocate one audio MCU and commit all of its devices to it.

Some current solutions rely on a leader device to commit all of the system's devices to one of the resources. The leader device is often one of the system's computing devices that has been pre-selected and altered to be capable of committing the system. These current solutions, however, may be vulnerable to the leader device failing in some way. If the leader device commits the system to a particular resource and then crashes, for example, other computing devices may no longer be able to use the resource or may have their operations fail.

### SUMMARY

This document describes tools that enable fault-tolerant resource committal for a system having computing devices needing to have operations of a particular type performed by one of multiple external resources. The tools may do so without relying on leadership from a pre-selected or altered computing device. Assume, for example, that the system is a conferencing system, the computing devices are front-end servers, the operations of a particular type are those that require handling of audio from users in the conference, and the external resources are homogeneous audio multi-point control units (MCUs) each of which is capable of handling audio from all of the users. The tools may enable, in one embodiment, any of the front-end servers to allocate a single audio MCU and commit all of the other front-end servers to use that single MCU for their audio operations.

This Summary is provided to introduce a selection of concepts in a simplified form that are further described below in the Detailed Description. This Summary is not intended to identify key or essential features of the claimed subject matter nor is it intended to be used as an aid in determining the scope of the claimed subject matter. The term “tools,” for instance, may refer to system(s), method(s), computer-readable media, and/or technique(s) as permitted by the context above and throughout the document.

### BRIEF DESCRIPTION OF THE DRAWINGS

FIG. 1 illustrates an exemplary operating environment in which various embodiments of the tools may operate.

FIG. 2 is an exemplary process illustrating ways in which the tools enable a front-end server of a conferencing system to allocate an audio multi-point control unit for use by all of the front-end servers of the conferencing system.

FIG. 3 illustrates exemplary elements, some of which are examples of those set forth in FIG. 1, that are used in the description of the process of FIG. 2.

FIG. 4 is an exemplary process illustrating various embodiments and manners in which the tools may enable fault-tolerant committal of external resources.

The same numbers are used throughout the disclosure and figures to reference like components and features.

### DETAILED DESCRIPTION

### Overview

The following document describes tools capable of enabling fault-tolerant resource committal for a system having computing devices needing to have operations of a particular type performed by one of multiple available external resources.

The tools may do so, in some embodiments, using a shared data store. Assume, for example, that two of a system's devices determine based on information in the shared data store that the system has not committed to an external resource. In response, they may each allocate different external resources independently. Then one of the devices contacts the shared data store more quickly than the other, determines anew based on information currently in the shared data store that the system is still not committed to an external resource, and then indicates its external resource in the shared data store. This indication in the shared data store commits the system to the first external resource.

The second device then determines, based on the indication from the first device in the shared data store, that the system is now committed to the first device's external resource. This second device rolls back its allocation of a different external resource and then uses that first external resource. Any other devices that later need to allocate an external resource may check the shared data store and determine that an external resource has already been committed. And if the first device fails the other devices may continue to use the external resource.

An environment in which the tools may enable these and other actions is set forth below in a section entitled Exemplary Operating Environment. This section is followed by another section describing an exemplary way in which front-end servers of a conferencing system may act to enable fault-tolerant committal of an audio MCU and is entitled Example Conferencing System. A final section describes various other embodiments and manners in which the tools may enable fault-tolerant committal and is entitled Other Embodiments of the Tools. This overview, including these section titles and summaries, is provided for the reader's convenience and is not intended to limit the scope of the claims or the entitled sections.

### Exemplary Operating Environment

Before describing the tools in detail, the following discussion of an exemplary operating environment is provided to assist the reader in understanding ways in which various inventive aspects of the tools may be employed. The environment described below constitutes but one example and is not intended to limit application of the tools to any one particular operating environment, system, type of computing device, type of external resource, or operation. Others may be used without departing from the spirit and scope of the claimed subject matter.

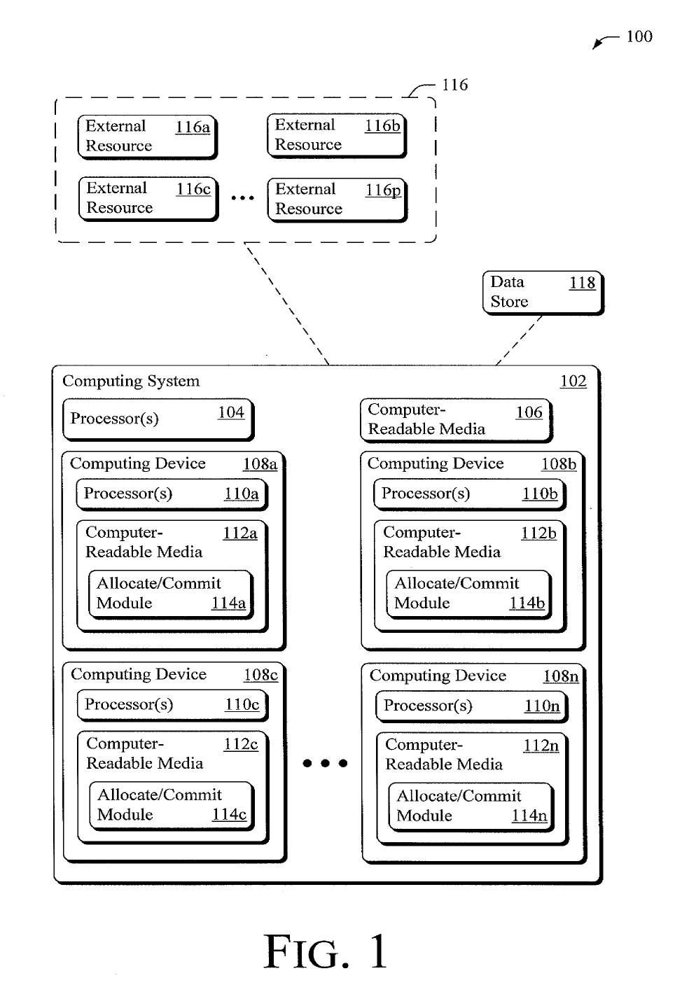

FIG. 1 illustrates one such operating environment generally at 100 comprising a computing system 102 having one or more processors 104 and computer-readable media 106. The system's processors are capable of accessing and/or executing computer-readable instructions on the computer-readable media. The system comprises or has access to an arbitrary number n, of computing devices 108. These devices may stand alone or be executable on the system's processors and stored in the system's computer-readable media. The system may have many different structures and uses, as will be understood by the skilled artisan. The system may include, for example: a conferencing system; a printing system; a file-using system; and a processing system with its computing devices being processing threads.

The computing devices are designated 108a, 108b, 108c, through 108n. Each computing device's processors 110 are capable of accessing and/or executing computer-readable instructions on their computer-readable media 112. Each device's computer-readable media comprises or has access to an allocate/commit module 114. Note that each of these elements is designated with “a”, “b”, “c”, and “n” corresponding to their computing device.

The computing devices may have more than one type of operation for which they use external resources. For example, the computing devices may send their audio to one external resource and their video to another.

The computing devices may be homogenous (and thus the system be distributed) in the sense that no particular computing device is a coordinator of the others, preferred, and/or pre-selected to commit the system to a particular external resource. Furthermore, in some embodiments all of the computing devices are identical in the sense that an action (e.g., handling audio sent from a user) is guaranteed to succeed if sent to any one of the computing devices. The computing devices are also capable of communicating with a shared data store 118 and, in some embodiments, may each retain information locally.

External resources 116 are designated 116a, 116b, 116c, through 116p in FIG. 1. Any one of the external resources is capable of handling a particular type of operation from multiple computing devices 108 (shown with a dashed line between the resources and the system). Exemplary external resources may include, for example: printers; recording components; publishing components; file-system directories for storing content; and MCUs (audio media, video media, application sharing, recording, gaming, or otherwise).

Date store 118 is accessible, directly or indirectly, by computing devices 108 and may be part of or separate from computing system 102 (both shown with a dashed line) and may execute operations through elements of the computing system including with its own allocate/commit module (not shown). The data store may, for instance, execute operations on behalf of computing devices 108 and in a transactional manner. At some point the data store may include information indicating whether the system or a computing device has allocated or committed to a particular external resource. In some embodiments the data store is one that will not necessarily fail when any one of the computing devices fails, including the computing device that commits the system to a particular external resource.

### Example Conferencing System

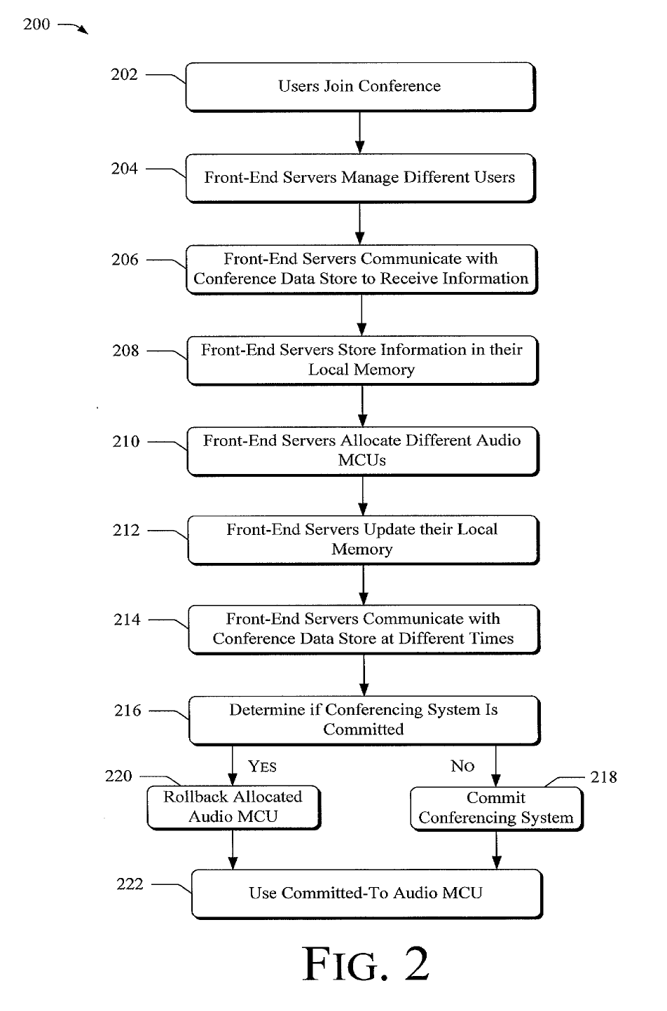

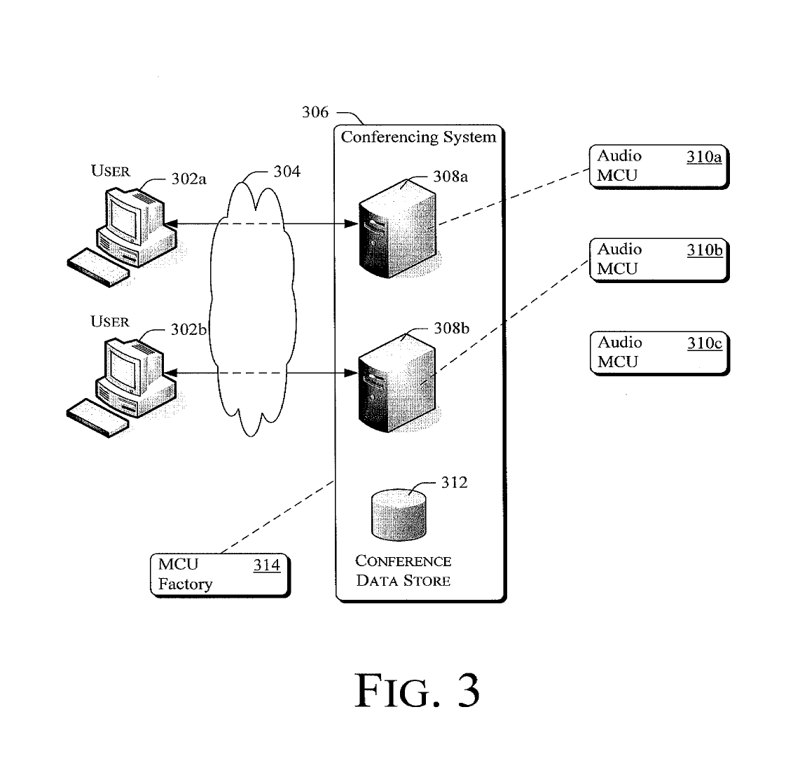

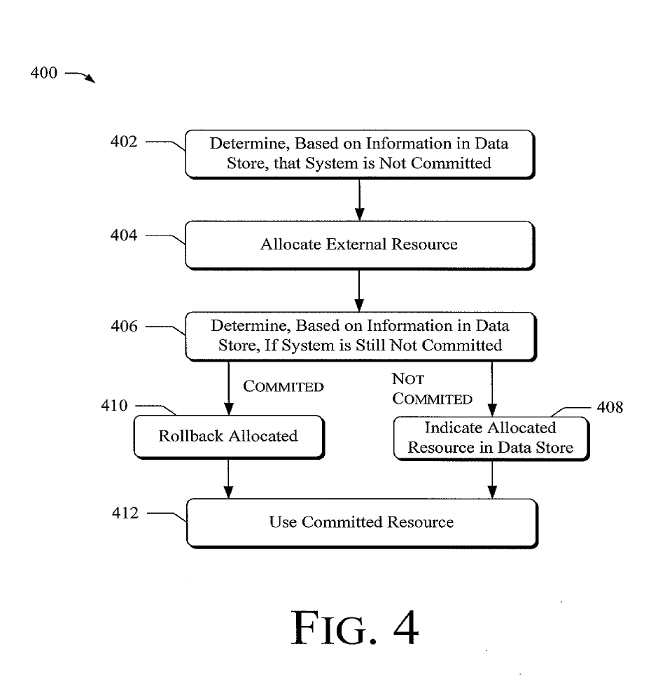

In this section a conferencing system using two front-end servers, audio MCUs, and a shared data store are used to describe one exemplary way in which the tools act to enable fault-tolerant resource committal. This example is provided for the reader's understanding; it is not intended to limit the scope of the tools or the claimed embodiments. This example is primarily illustrated in FIGS. 2 and 3. A more-general embodiment referring to this and other examples is set forth in FIG. 4.

Process 200 of FIG. 2 is illustrated as a series of blocks representing individual operations or acts performed by front-end servers of FIG. 3. These and other processes described herein may be implemented in any suitable hardware, software, firmware, or combination thereof; in the case of software and firmware, these processes represent sets of operations implemented as computer-executable instructions stored in computer-readable media and executable by one or more processors.

At block 202, users 302a and 302b of FIG. 3 attempt to join a conference. The users have audio and video media to send to the conference, here through a communications network 304, and desire to receive audio and video of other conference members. For clarity and simplicity, this example process is concerned only with handling audio media received from two users 302a and 302b.

FIG. 3 illustrates particular examples of elements described in FIG. 1 and other elements all of which will be used in describing this embodiment. Users 302a and 302b are shown with desktop computers, which have audio and video receiving and displaying abilities, though other computers or non-computers (e.g., some telephones) may also be used. Conferencing system 306 is one example of computing system 102 and has processors and computer-readable media (not shown). Front-end servers 308a and 308b are examples of computing devices 108a and 108b and have processors, computer-readable media, and allocate/commit modules through which actions of process 200 may be performed (not shown). Audio multi-point control units (MCUs) 310a, 310b, and 310c are examples of external resources 116. Conference data store 312 is an example of data store 118 and may include a SQL database or a distributed hash table.

At block 204, front-end servers 308a and 308b manage different users, here users 302a and 302b, respectively. At this point each of the front-end servers may have already determined that the conferencing system has committed to a particular audio MCU, though here we assume that neither has done so yet.

At block 206, both of the front-end servers communicate with conference data store 312 to receive information indicating whether or not the conference has committed to an audio MCU. If the conferencing server has, then both front-end servers can use the committed-to audio MCU dump to block 222). Here we assume that the conferencing system is not committed.

The conference data store contains information about which conference (if the system may manage multiple conferences), which types of external resources are or may in the future be committed to, which version of the particular type of external resource is used (or not being used), and which particular external resource for each type is being used, if any. Here the conference is the conference the users are attempting to join, the type of external resource is an audio MCU (indicated by <MCUInformation> in the data store), and no audio MCU has been committed to (indicated by <null,0> in the data store). When the front-end servers contact the data store and ask whether or not an audio MCU is being used for the conference desired by the users, they both receive <null,0> (“null” indicating that no audio MCU is committed to and “0” indicating a zero version) because the system has not committed to an audio MCU.

At block 208, each of the front-end servers store information (here <null,0>) in their local memories (not shown).

At block 210, each of the front-end servers allocate different Audio MCUs, here through a GetMCU command made to an MCU factory 314 shown in FIG. 3. The MCU factory determines which of its resources is appropriate to handle the requested operation (here the particular operation of handling audio from a user and intended for a conference). The MCU factory returns audio MCU 310a to front-end server 308a and audio MCU 310b to front-end server 308b, respectively.

At block 212, each of the front end servers updates their local memory. Front-end server 308a updates its memory by recording the audio MCU allocated, here with <0,AudioMCUa>. Likewise, front-end server 308b updates its memory by recording the audio MCU allocated, here with <0,AudioMCUb>.

At block 214, each of the front-end servers communicates with the conference data store at a different time. Here front-end server 308a communicates with the conference data store first. This communication includes a call to the conference data store with the information <AudioMCUa, 0> that the front-end server previously stored. Note that each of the front-end servers has allocated an audio MCU independent of the other front-end server or information local to the other front-end server (e.g., the other front-end server's transient state). The process will return to actions of front-end server 308b later below.

At block 216, the conference data store on behalf of the front-end server and in a transactional manner determines if the conferencing system is committed. If no, the process continues to block 218. If yes, to block 220. Here conference data store 312 on behalf of front-end server 308a compares the current information in the conference data store, <null,0>, with the information in the server's local memory, also <null,0>. These same version numbers “0” and “0” indicate that the system has not committed to an audio MCU since the front-end server last contacted the conference data store. In response, the process continues to block 218.

At block 218, the conference data store on behalf of the front-end server commits the conferencing system to its allocated audio MCU by indicating audio MCU 310a in the conference data store. Thus, the store is updated with <0,AudioMCUa>, which reflects the new resource and that it is a new version. Thus, it replaces “null” with “AudioMCUa” and “0” with “1” for: <AudioMCua,1>.

At block 222, the front-end server uses the conferencing system's committed-to audio MCU, here audio MCU 310a to handle user 302a's audio.

After front-end server 308a communicates with the conference data store front-end server 308b communicates with it, also according to block 214. The second front-end server (308b) receives from the conference data store the audio MCU to which the system is committed, if any. Here the conference data store returns <AudioMCUa,1>, not <null,0>. This is because the first front-end server 308a caused the update to the conference data store responsive to its communication at block 216.

At block 216 the conference data store on behalf of the front-end server and in a transactional manner determines if the conferencing system is committed. Here conference data store 312 on behalf of front-end server 308b compares, from the front-end server's local memory, <null,0> with the current information in the conference data store, <AudioMCUa,1>. The different version numbers “0” and “1” indicate that the system has committed to an audio MCU since the front-end server 308b last contacted the conference data store. In response, the process continues to block 220.

At block 220, the conference data store on behalf of the front-end server rolls back its allocation of audio MCU 310b. At block 222, the front-end server uses the committed-to audio MCU 310a. These last two blocks are effective to reallocate audio MCU 310a thereby replacing audio MCU 310b.

If audio MCU 310a fails, the process may be repeated but with some differences. Both of the front-end servers may communicate with the data store at block 206 and, if the resource has not yet been replaced, learn that the current version is still “1” (from receiving <AudioMCUa,1>). At block 208, both front-end servers record this in local memory, and then at block 210 allocate different audio MCUs. Here the newly allocated audio MCUs comprise audio MCU 310b and audio MCU 310c, which the front-end servers would record at block 212. At block 214, the front-end servers communicate again with the data store but again at different times. Assume here that front-end server 308b communicates first and receives again <AudioMCUa,1> from the data store.

At block 216 the conference data store on behalf of this front-end server determines that the conference is still not committed to a valid MCU (it may be committed to audio MCU 310a, but the front-end server knows that this resource is invalid) because the version number just received “1” is the same as the one received at block 206, also “1”. Because the conference is not committed to a valid audio MCU, the process for this front-end server 308b proceeds to block 218 and commits the conferencing system to the newly allocated audio MCU 310b. Again, this committal is done with an indication in the conference data store (here with <AudioMCUb,2>). The process for this front-end server then proceeds to block 222 and uses the committed-to audio MCU 310b.

The other front-end server 308a, through the conference data store, determines that the conference system has committed to a valid audio MCU 310b at block 216 and based on information from actions at block 214 and 206. Thus, the conference data store on behalf of this front-end server compares the current version number in the conference data store “2” from when front-end server 308b indicated <AudioMCUb,2> to the front-end server's previously received version, namely “1”. As the conference system has committed, front-end server 308a proceeds to blocks 220 and 222, reallocating its allocated audio MCU 310c with audio MCU 310b. Note that each of the front-end servers (on its own or transactionally through the data store) is equally capable of allocating and then committing the conference system to a resource, whether that be an initial resource or a replacement. The front-end servers may do so independent of each other's local information.

### Other Embodiments of the Tools

The section above describes exemplary ways in which the tools may act to enable fault-tolerant resource committal in a conferencing system using a data store. The section below describes additional embodiments of the tools, including a process 400 shown in FIG. 4, which is illustrated as a series of blocks representing individual operations or acts preformed by the tools. These embodiments of the tools are not intended to limit the scope of the tools or the claims.

Block 402 determines, based on information in a data store accessible by devices of the system, that a system having computing devices needing to have operations of a particular type performed by one of multiple external resources all of which are capable of performing operations of the particular type has not committed its computing devices to a valid external resource. The tools may do so through an allocate/commit module 114 in one or more of computing devices 108 or 308, for example.

The tools may receive information from the data store (e.g., data store 118 or conference data store 312) indicating that no valid external resource capable of handling the particular type of operation is committed to by the system. This information may indicate that the system is not committed to an external resource or that it is committed and the resource is invalid or is known by the devices to be invalid. In either case, the tools enable a new and valid external resource to be allocated and committed for the system.

This information may also include indications of the type of external resource (one that is capable of handling the type of operation desired) and an order or commitment-time for that external resource. The order or time of the external resource (or lack thereof) may include a version number (e.g., as described in the above example of FIGS. 2 and 3) or time-stamp, for example. This information may also indicate whether a committed-to external resource is valid or not, though that may already be known by the computing devices.

Block 404 allocates an external resource capable of handling the particular type of operation. The tools may do so in manners known to a skilled artisan, such as through an internal computation by a computing device or by contacting some other entity (e.g., the allocate/commit module 114 of one of the computing devices 308 commanding an MCU factory to allocate a resource). Note that at this point one or many computing devices of the system may have determined that the system is not yet committed to a valid external resource. In response each may allocate an external resource at block 404.

Block 406 determines, based on information in a data store accessible by the devices of the system, whether or not the system has committed its computing devices to a valid external resource. This information may be from the same data store contacted at block 402 or otherwise.

In some embodiments the allocate/commit module of one of the computing devices of the system determines whether a version or time-stamp in the data store indicates that a newer external resource is now being used by the system. If at block 402 the data store indicated a version number, such as “0” or “1” or a time-stamp that is now out-of-date, such as with a “1” or “2” or higher time-stamp, the allocate/commit module may determine that the system has now committed to a valid external resource. If the system is not committed, the tools proceed to block 408. If it is committed, the tools proceed to block 410.

Block 408 indicates in a shared data store an allocated external resource effective to commit the system to that allocated external resource. Note that any future computing device does not need to contact or rely on a computing device that allocated and committed the system to the external resource. Instead, each device may determine the system's committed-to external resource through this indication in the data store, such as with a handle or path name for the resource. Thus, all of the computing devices that now or later desire to use an external resource for the particular type of operation will use the indicated external resource (unless it is later replaced). Devices that have allocated another external resource may determine that the indicated resource should be used instead, such as with a version number or time-stamp higher in number or later in time than the other device received at block 402. In the above example of FIGS. 2 and 3, for instance, the tools indicated this with a version number.

Block 412 uses the external resource to which the system is committed. Here the external resource is an allocated external resource indicated in the data store by the computing device that most quickly contacted the data store with a valid allocated external resource.

Block 410 rolls back an allocated external resource. Here the computing device or other entity allocated an external resource but determined, at block 406, that the system is already committed to a valid external resource. Every computing device that allocates an external resource when one is already committed to by the system may dump its allocated resource in preparation of using the system's committed-to external resource. In the above example, all of the front-end servers are enabled by the tools to send their user's audio to the same audio MCU even if they have allocated a different audio MCU.

In some cases only one computing device determines that the system is not committed to an external resource. Later computing devices may then learn at block 402 that the system is committed and then jump to block 412 to use that resource. In some other cases, however, many devices may learn that the system is not committed at block 402 before any one of them commits the system at block 408. All of the devices after the first (the one that commits the system at block 408) will then determine that their allocated external resource is not needed, roll it back, and then use the system's committed-to resource. Note that all of the devices that later need to use the system's committed-to resource may do so without relying on the robustness of the computing device that committed the system. If that computing device fails, the data store will not likely also fail, thereby permitting the other devices to determine that the system is committed and to which external resource.

The tools may enable any of the computing devices to replace an external resource with a new resource (e.g., to replace an invalid resource such as described in the embodiment of FIGS. 2 and 3). They may do so without regard to any one of the computing devices being preferred or leading the others or information local to it. Any of the computing devices may do so at any time, such as during the middle of a telephone conference when an audio MCU fails or otherwise should be replaced.

Note that the tools may also enable these actions for many types of systems, computing devices, operations, and external resources. For example, the system can be a printing system, each of the devices can be capable of preparing a portion of a document for printing, the particular type of operation can be printing the document for which the portions are prepared, and the external resources can be printers each of which is capable of printing all of the portions of the document.

### CONCLUSION

The above-described tools enable fault-tolerant resource committal for a system having computing devices needing to have operations of a particular type performed by one of multiple external resources. The tools may do so without relying on leadership from a pre-selected or altered computing device. By so doing, systems with computing devices needing to use one of multiple external resources may be made more fault-tolerant. Although the tools have been described in language specific to structural features and/or methodological acts, it is to be understood that the tools defined in the appended claims are not necessarily limited to the specific features or acts described. Rather, the specific features and acts are disclosed as exemplary forms of implementing the tools.

1. A method implemented at least in part by one or more computer processors comprising:
determining that a system having computing devices needing to have operations of a particular type performed by one of multiple external resources all of which are capable of performing operations of the particular type has not committed its computing devices to one of the resources and based on information in a data store accessible by all of the computing devices;
allocating one of the resources to perform an operation of the particular type;
determining, based on information in the data store, that the system still has not committed to another of the resources; and
indicating in the data store said one of the resources effective to enable any of the devices to determine that the system is committed to said one of the resources.

2. The method of claim 1, further comprising:
determining that said one of the resources indicated in the data store is invalid;
allocating a new one of the resources;
determining, based on information in the data store, that the system still has not committed to another new resource of the resources; and
indicating in the data store said new one of the resources effective to enable any of the devices to determine that the system is committed to said new one of the resources.

3. The method of claim 1, wherein the act of indicating is effective to enable any of the devices to determine that the system is committed to said one of the resources without any of the devices needing to communicate with any other of the devices.

4. The method of claim 1, wherein the acts of determining, allocating, determining, and indicating are performed by a first computing device of the computing devices of the system, and further comprising performance of the following acts by a second computing device of the computing devices of the system:
determining, prior to the first device's act of indicating and based on information in the data store, that the system has not committed its computing devices to one of the resources;
allocating another of the resources to perform an operation of the particular type for the second of the computing devices;
determining, based on information in the data store including the indication and after the first device's act of indicating, that the system has committed to said one of the resources; and
rolling back said another of the resources and reallocating said one of the resources to perform the operation of the particular type.

5. A system comprising computing devices, each of the devices:
needing to have an operation of a particular type performed by one of multiple external resources all of which are capable of performing operations of the particular type and can be allocated to the system; and
independently capable of committing the system to one of the resources by indicating in a data store accessible by any other of the computing devices said one of the resources effective to enable said other devices to determine that the system is committed to said one of the resources without relying on information available only through the computing device that committed the system.

6. The system of claim 5, wherein the capability of committing the system is enabled by:
determining, based on information in the data store, that the system is not committed to any of the resources;
allocating said one of the resources; and
determining, based on information in the data store, that the system is still not committed to any one of the resources,
wherein the act of indicating is responsive to determining that the system is still not committed.

7. The system of claim 5, wherein each of the computing devices is further independently capable of replacing said one of the resources to which the system is committed with a new one of the resources using information available in the data store accessible by all of the computing devices and without relying on information available only through any other of the computing devices.

8. The system of claim 5, wherein the capability of committing the system is capable of requiring all of the devices to use said one of the resources for their operation of the particular type.

9. The system of claim 5, wherein each of the computing devices is leaderless to the extent that no one of the computing devices is pre-selected to commit the system.

10. The system of claim 5, wherein each of the devices is independently capable of committing the system using its own local information.

11. The system of claim 5, wherein the information available only through the computing device that committed the system comprises that device's transient state.

12. The system of claim 5, wherein the system is a conferencing system, each of the devices is a front-end servers the particular type is audio media, video media, application sharing, recording, or gaming and the external resources are audio multi-point control units, video multi-point control units, application sharing multi-point control units, recording multi-point control units, or gaming multi-point control units.

13. The system of claim 12, wherein each of the front-end servers is equally capable of committing the system to one of said audio multi-point control units or one of said video multi-point control units.

14. The system of claim 5, wherein the system is a printing system, each of the devices is capable of preparing a portion of a document for printing, the particular type is printing the document for which the portions are prepared, and the external resources are printers each of which is capable of printing all of the portions of the document.

15. The system of claim 5, wherein the system is a processing system and each of the computing devices is a processing thread.

16. One or more computer-readable media having computer-readable instructions therein that, when executed by one or more processors, cause the processors to perform acts comprising:
determining that a conferencing system having front-end servers needing to have media from users handled by one of multiple external multi-point control units (MCUs) all of which are capable of handling the media has not committed its front-end servers to one of the MCUs and based on information in a conference data store accessible by the front-end servers;
allocating one of the MCUs to handle the media for one of the front-end servers;
determining, based on information in the conference data store, that the conferencing system still has not committed to another of the MCUs; and
indicating in the conference data store said one of the MCUs effective to enable other of the front-end servers to determine that the conferencing system is committed to said one of the MCUs.

17. The media of claim 16, wherein the first act of determining comprises receiving a first version number from the conference data store and the second act of determining comprises receiving the first version number again effective to indicate that the conferencing system has still not committed to another of the MCUs.

18. The media of claim 16, wherein the act of indicating comprises storing a version number or time-stamp different from an original version number or original time-stamp received based on the information in the conference data store as part of the first act of determining.

19. The media of claim 16, wherein the media is audio media and the MCUs are audio MCUs.

20. The media of claim 16, further comprising:
determining, responsive to determining that said one of the MCUs is invalid and is committed to by the conferencing system and based on information in the conference data store, that the conferencing system has not committed to a new MCU of the MCUs; and
indicating in the data store a new one of the MCUs effective to enable other of the front-end servers to determine that the conferencing system is committed to said new one of the MCUs.
